(19) United States
(12) Patent Application Publication
(10) Pub. No.: US 2003/0159869 A1
(43) Pub. Date: Aug. 28, 2003

(54) Motorization of a bicycle with a simple replacement of the bottom bracket

(76) Inventor: Michael Stuart Trerice, Halifax (CA)

Correspondence Address: Michael Retallack, 6138 Regina Terrace, Halifax, NS, B3H1N5, CA

(21) Appl. No.: 10/361,189

(22) Filed: Feb. 10, 2003

(30) Foreign Application Priority Data
Feb. 28, 2002 (CA) 2,2376787

(51) Int. Cl. B62K 11/00

(52) U.S. Cl. 180/205

(57) ABSTRACT

In a motorization of a conventional bicycle, there is an addition of a driven gear to the bicycle chain gear or gears in the bottom bracket area. The driven gear receives a chain from a drive gear, which is the output mechanism of a motor that is strapped to the frame of the bicycle, and transfers power from the motor to the bicycle chain gears that are fixed to this driven gear. Between the driven gear and powered bicycle chain gear or gears and the pedal crank shaft is a one way clutch, which is oriented so that the motor can turn and transmit its torque through the powered gears and bicycle chain to the rear wheel while the pedals are at rest. A second clutch is provided for the motor, which is not a one way clutch, but rather is a clutch that can be controlled in the degree of its engagement by the operator of the bicycle.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

This invention relates to the motorization of a conventional bicycle, so that the bicycle can be driven either by power supplied by the pedals, or by a motor which is strapped to the frame of the bicycle, or by a combination of power from both sources.

The addition of a motor to small vehicles goes back as far as the development of the internal combustion engine. The earliest motorcycles included pedals, that were used both as a means to start the engine and as a backup in case the engine failed, and since that time there has continued to be a number of the vehicles known as mopeds. These vehicles are similar to bicycles in that they are smaller than motorcycles and in that they are provided with pedals, but are dissimilar in that they are constructed from the start with motors incorporated into their frame and essential features. This is not an adaptation of the standard bicycle, which aims to provide an affordable mode of transportation by means of a simple addition to these existing structures.

Among the various schemes for motorization of an actual bicycle, some describe an adaptation of the frame, and then others involve a shaft driven mechanism instead of the usual chain to the rear wheel. In either of these two cases, the adaptation will require a major reconstruction of the bicycle, and the effort begins to look more like the production of a moped, as described above. Examples of these arrangements can be found in the patent literature, for example in U.S. Pat. Nos. 6,152,251 and 5,375,676.

Other approaches involve either a wheel mounted motor or a motor so small that it can be placed in the hub of the wheel itself The wheel mounted motors fail to take advantage of the unused spaces within the frame of the bicycle, but instead add bulk and mass onto the wheel and onto the sides of the bicycle, which can affect balance and handling. The powered hubs make use of the natural space within the wheel itself, but due to constraints on the size of the motor, both these and the wheel mounted motors are in general limited to electrical devices. Electrical motors have their own limitations, for example with respect to the amount and duration of power output. Batteries are required, and even with the availability of appropriate devices to recharge the system, it would take time to complete the process. This constitutes a severe limitation on the range of electric powered bicycles, since they cannot make use of all the gas stations that are provided for the use of other motor vehicles. Examples of wheel mounted motors and hub motors are described in U.S. Pat. Nos. 5,368,122 and 6,278,216 and in Canadian patent 2162504.

Perhaps the most common of arrangements for the motorization of a bicycle involve powered rollers that make direct contact with either the front or rear wheel. The road wheel is then driven by the motor through a frictional engagement of the powered rollers on the tire. Perhaps the most obvious of difficulties with this frictional engagement would be in bringing the powered roller into contact with the tire, and then keeping it there with enough pressure to drive the bicycle and without pressing too hard on the wheel. This arrangement seems likely to slip when power is most desired, for example when climbing a hill, or else to interfere with the free rotation of the wheel and to work against the efforts of the motor or pedals. Examples of roller driven bicycles are given in U.S. Pat. Nos. 6,102,148 and 4,418,784 and in Canadian patent 2019025.

Still other arrangements make use of a second chain to the rear wheel, in addition to the usual bicycle chain which carries drive from the pedals to the rear sprocket area. This second chain requires the addition of a gear or gears onto the rear wheel, and then this modified wheel must be fit into the existing frame, with the added chain and motor fit into the spaces around or between the pedals and seat post and so on. While this arrangement does make a positive engagement between the motor and the rear hub, in contrast with the frictional engagement of powered rollers, it would seem much easier to leave the construction of the rear half of the bicycle unaltered, and to use the existent transmission back to the rear wheel, if this were possible. Also, in the case of multi gear bicycles, this configuration fails to make use of available gear ratios that are already in place. Examples of motorized bicycles with a second chain to the rear wheel are given in U.S. Pat. Nos. 6,305,485 and 4,541,500 and in Canadian patent 207859.

There have been a number of efforts to connect a motor to the bicycle chain or chain rings (gears) in the bottom bracket area, and through this connection to power the bicycle chain and therefore the bicycle as a whole. A number of these efforts have involved a one way clutch for the motor but not for the pedals, so that if the motor is used then the rider has no choice but to pedal along. The rider can pedal the bicycle without the use or interference of the motor, but the motor cannot be used as the sole means to propel these power assisted bicycles. These kinds of arrangements are referred to in Canadian patent 2162504, and the mechanisms described in U.S. Pat. Nos. 4,085,814 and 4,393,954 appear to be two of this kind.

Others have included separate one way clutches for the motor and for the pedals, so that either can be used alone. It would seem, however, that the inclusion of a different kind of clutch for the motor can have functional advantages. A one way clutch for the motor does not allow the motor to be disengaged from the drive train to the rear wheel, for example when the bicycle is brought to a stop. It would seem, in this case, that the motor has to be restarted each time the bicycle is brought into motion, or else that a third clutch would need to be introduced. Furthermore, the engagement of a one way clutch is all or none, and in connection with a motor might even result in sudden and dangerous applications of power. Examples of motorized bicycles with separate one way clutches for the motor and for the pedals include those described in U.S. Pat. Nos. 5,941,332 and 5,242,028.

At the level of bicycle parts in general, several patents were found that did incorporate a single one way clutch for the pedals, so that the bicycle chain can move while the pedals are at rest. These were, however, intended for a different purpose, which was to allow the bicycle to change gears without the need for the rider to drive the chain. There is, in these patents, no mention of a motor or of a gear dedicated to receive power from a motor. The patents referred to here are U.S. Pat. Nos. 5,426,997, 4,183,262 and 4,154,123.

### BRIEF SUMMARY OF THE INVENTION

In consideration of the prior art, it is an object of this invention to provide an affordable mode of transportation, with a simple addition of a motor to the existing structure of a bicycle, and without a reconstruction of the frame or other extensive alterations to the bicycle. This adaptation of a common bicycle aims to make use of the natural spaces within its frame, so that it is capable of, but not limited to, the incorporation of a gasoline powered engine. It is furthermore an object of this invention to make a positive engagement between this motor and the existent bicycle chain transmission to the rear wheel, which can allow the pedals to remain at rest while the motor powers the bicycle, or alternatively, the pedals to be used in addition to the motor or as the sole means to propel the bicycle. These last few objectives are achieved through the inclusion of a one way clutch for the pedals, and a clutch capable of controlled and graduated engagement for the motor.

In accordance with the first of these stated objectives, a motor is provided with points of attachment for straps, which can then be wrapped around the frame of the bicycle at various points, for the simple attachment of the motor to the bicycle. These straps might be made of metal or of some other material, depending on the requirements of the particular configuration.

The space to be used for the location of the motor and its associated components would be that positioned between what are sometimes named the seat tube and head tube, and under what is called the top tube of the bicycle frame. This space is unused and large enough in most bicycles to provide for whatever motor would be desired in connection with the bicycle. The motor itself might be gasoline powered or electrical and powered by conventional rechargeable batteries. In another configuration, fuel cells could be used to power the engine.

The motor is also provided with a clutch for the engagement or disengagement of a drive gear, which is the output mechanism from the motor. This clutch is capable of graduated engagement, and can be controlled in the degree of its engagement through manual controls that are available to the operator of the bicycle, so that power from the motor can be smoothly applied to driven and powered gears, and therefore to the rear wheel. This clutch might be a centrifugal clutch, in which case the degree of engagement would be under indirect control, through the control of the RPM of the motor. In this case, the engine could be started in advance of the use of the bicycle, and when power from the motor is desired, the RPM of the motor would be increased to the extent that the clutch is engaged and the motor is connected to the drive train. Alternatively, the degree of engagement of this clutch could be under direct control by the operator. In the case of this manual clutch, the motor can be disconnected from the drive train when it is not intended to be used. When the motor is intended to be started, and in the case of a gasoline powered engine, this clutch can be engaged and the power of the pedals can be used to drive the motor and start the engine. When the motor is started, it can be used to power the bicycle, either alone or with an added effort from the rider. There are the same possibilities for controlled delivery of power from the motor, with the manual clutch as with the centrifugal clutch, and the engine can be disconnected from the drive train, for example when bringing the bicycle to a stop. In contrast with designs that include a one way clutch for the motor, this allows the engine to continue to run when the bicycle is not in motion, and then the power from the motor can be smoothly increased in bringing the bicycle back into motion.

The drive gear, which is the output mechanism from the motor, is connected to a driven gear which is mounted on the same axis of rotation as the bicycle chain gears in the bottom bracket. This connection could be made by means of a chain similar to the usual bicycle chain, which would span the distance between these two gears in an adjustable fashion, so that the motor can be fit onto an assortment of different bicycles. A replacement of the pedal crank shaft in the bottom bracket would allow for the insertion of the driven gear in addition to the gear or gears for the transmission of the bicycle chain to the rear wheel. One or more of these bicycle chain gears are rigidly fixed to this driven gear, and therefore can also be powered by the motor. Between the driven gear and powered bicycle chain gear or gears and the pedal crank shaft is a one way clutch, which is oriented so that the motor can turn and transmit its torque through the powered gears and bicycle chain to the rear wheel while the pedals are at rest. Conversely, if the pedals and pedal crank shaft are turned with respect to the powered gears, in the usual manner that is used to drive a bicycle, then this clutch can be engaged and power can be transmitted from the pedals to the powered gears.

In the case of a bicycle with a single bicycle chain gear in the bottom bracket area, the single gear would be replaced with two gears that are fixed relative to each other. One of these gears would be dedicated to receive the motorized chain from the motor, and the other would carry the bicycle chain that connects to the rear hub and wheel. These have been referred to as the driven gear and the powered gear, respectively. In the case of a bicycle with multiple bicycle chain gears in the bottom bracket area, at least one of the bicycle chain gears in the replacement would be fixed in relation to the driven gear. The others would be fixed in relation to the pedal crank arm, as are the usual bicycle chain gears, and in order to make use of the motor and powered gears, it would be necessary to shift the bicycle chain onto these powered gears through the usual means. It would also be necessary, in the case of a gasoline powered engine, to shift the bicycle chain onto the powered gears before attempting to use the pedals to drive the motor and start the engine. Operation of the system can be somewhat simplified if all of the bicycle chain gears are fixed as a unit to the driven gear, in which case the motor can be started and used in the manner already described, without the need to shift the bicycle chain onto a particular gear or gears.

Other objects, features and advantages of the present invention will become apparent from the following detailed description. It should be understood, however, that this detailed description and these specific examples, while indicating preferred embodiments of the present invention, are given by way of illustration and not limitation. Changes and modifications within the scope of the present invention may be made without departing from the spirit thereof, and the invention includes all such modifications.

### BRIEF DESCRIPTION OF THE DRAWINGS

FIG. 1 is a side view of a bicycle, with a motor in place and showing the connection between the drive and driven gears, in accordance with the present invention.

FIG. 2 is a perspective view of a replacement for the bottom bracket and its associated gears in the bicycle, as in the simplest embodiment of the invention, wherein there are only 2 gears in the bottom bracket area.

FIG. 3 is a top view of the same bottom bracket arrangement that was described in FIG. 2.

FIG. 4 is a top view of another arrangement for the gears in the bottom bracket area. In this case there are multiple gears, and two of these gears are fixed in relation to each other, whereas the others are separated from these first two.

FIG. 5 is a top view of a third arrangement, again in which multiple gears are incorporated, but in which all these gears are fixed in relation to each other.

All these figures are schematic in that details have been included only to the extent required for clarity in the description of the invention.

### DETAILED DESCRIPTION OF THE INVENTION

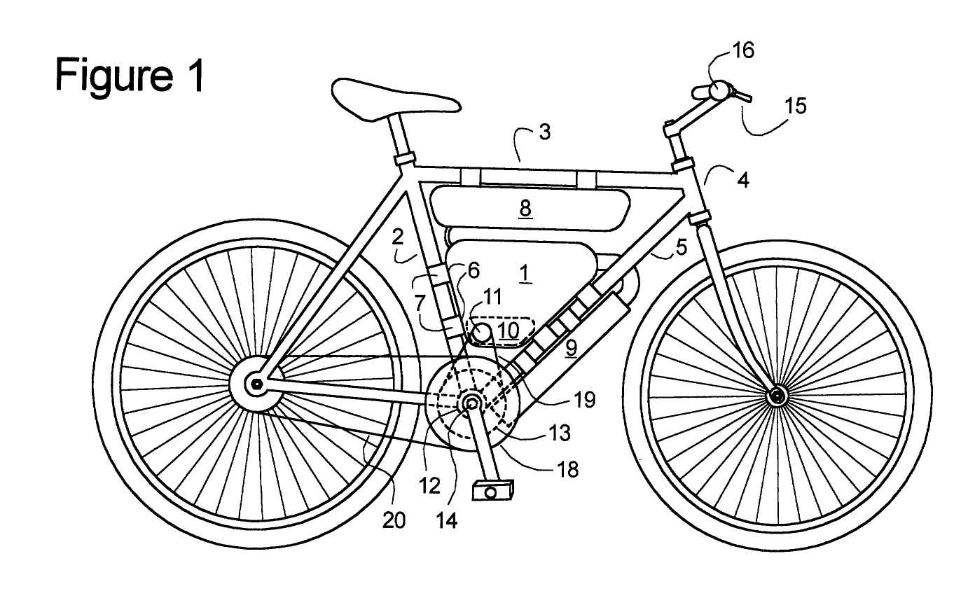

With reference initially to FIG. 1, a motor 1 is positioned within the frame of a bicycle, in the space between the seat tube 2, top tube 3, head tube 4 and angled down tube 5. The motor 1 is provided with points of attachment 6 for straps 7 that can then be used to attach the motor 1 to the frame of the bicycle. The straps 7 can be simply bolted onto the outer shell of the motor 1, or this outer shell could be moulded to provide slots through which the straps 7 would pass before being wrapped around the tubular elements of the bicycle frame and secured. Indentations could also be moulded into the outer shell of the motor 1, which would then fit over the seat tube 2 and down tube 5 to some extent and help to lock the motor 1 into position. Other components required in association with the motor 1, such as a gas tank 8 and a muffler 9 in the case of a gasoline powered engine 1, could be included as parts of the motor unit or else attached as separate pieces and strapped onto the bicycle in a similar fashion as was the motor 1 itself. It is this second configuration that is illustrated in FIG. 1.

The motor 1 is also provided with a clutch 10 for the engagement or disengagement of a drive gear 11, which is the output mechanism of the motor 1. This clutch 10 might be located in the bottom bracket area 12, between the driven gear 13 and the pedal crank shaft 14 of the bicycle, but is shown in FIG. 1 to be positioned within the motor unit 1 itself, where space is not so limited. This clutch 10 is capable of graduated engagement, and can be controlled in the degree of its engagement through manual controls that are available to the operator. Clutches of this kind are common in automobiles with standard transmissions and in motorcycles, and the clutch 10 incorporated into the present design could be a similar but smaller version of one of these, that would be suitable for the smaller engine 1 which is intended here. In this case, as in cars and motorcycles, the degree of its engagement could be under direct control through the operation of a lever. When the lever is in its resting position, the clutch 10 is engaged and the engine 1 is connected to the drive train. When the lever is pressed or pulled, the clutch 10 becomes disengaged to a proportional degree, until the lever is moved to the farthest extent of its range, in which case the clutch 10 is fully disengaged.

Instead of a separate lever for the clutch 10, a second connection could be made to one of the hand brake levers 15. In this case, the clutch 10 would become disengaged exactly when the lever 15 is pulled and the brakes are activated. When the brake lever 15 is released, the brakes would also be released and the clutch 10 would become engaged, in a gradual fashion. A second control for the clutch 10 would also be required, so that the clutch 10 can be disengaged when the motor 1 is not in use, while the lever 15 is still used to control the brakes. This second control could be a simple switch located on the motor unit 1 itself, and when the motor 1 is intended to be used, the clutch 10 could be switched on and engaged, after which time the hand lever 15 could be used to control the clutch 10 as described above. The amount of fuel or electrical power supplied to the engine 1 could be controlled by the rotation of one of the hand grips 16, in the same manner that is used in motorcycles.

In a second embodiment of the invention, the clutch 10 could be a centrifugal clutch, in which case the degree of engagement would be under indirect control, through the control of the RPM of the motor 1. In this case, the engine 1 could be started in advance of the use of the bicycle, for example through a pull start mechanism, and when power from the motor 1 is desired, the amount of fuel or electrical power supplied to the motor 1 could be increased through a hand grip throttle 16 as described above. In this case, there is no need for a hand lever control 15 for the clutch 10, or for the switch that was included for its initial engagement. The clutch 10 is disengaged until the RPM of the motor 1 is increased to a certain extent, at which point the clutch 10 becomes engaged and the motor 1 is connected to the drive train. Centrifugal clutches of this kind are sometimes used in mopeds, and the degree of their engagement is gradual and in proportion with the amount of fuel or electrical power supplied to the engine, so that the amount of power supplied from the motor to the moped can be smoothly increased or decreased. These same characteristics would be desired in the clutch 10 that is incorporated here. Examples where centrifugal clutches are incorporated into motorized bicycles or tricycles are given in U.S. Pat. Nos. 5,816,349 and 4,325,448 and in Canadian patent 532976. One example of the specific construction of a centrifugal clutch is given in U.S. Pat. No. 4,227,601.

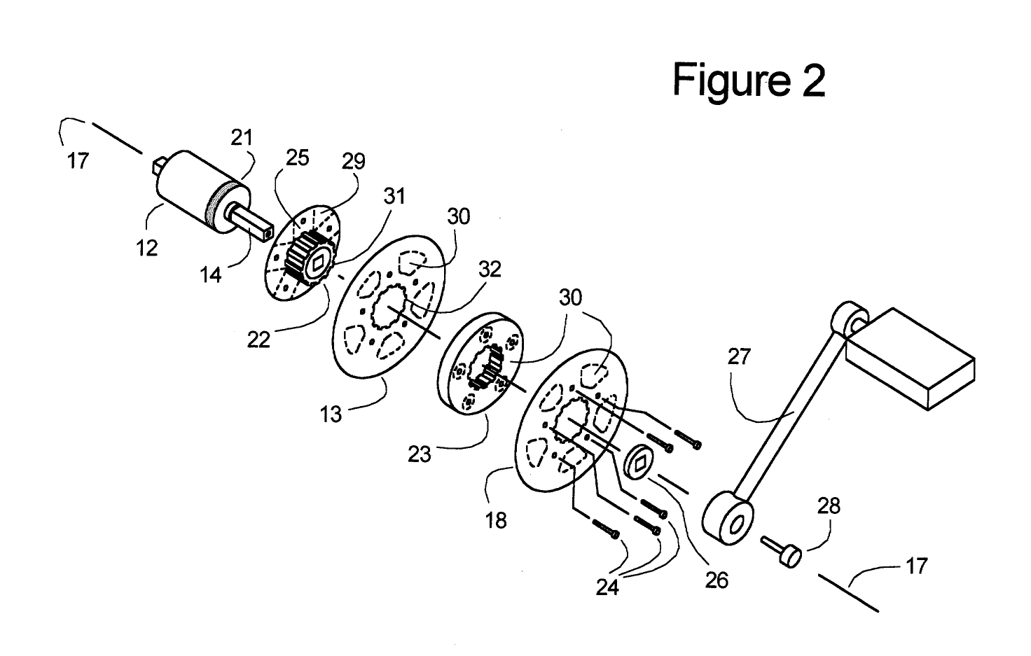

In either case, with direct or indirect control of the clutch 10 for the motor 1, the drive gear 11, which is the output mechanism from the motor 1, is connected to a driven gear 13 which is mounted on the same axis of rotation 17 as are the bicycle chain rings 18 in the bottom bracket 12. This connection could be made by direct contact of gears, between the drive gear 11 and driven gear 13, but is shown in FIG. 1 to consist of a chain 19 that could be similar to the usual bicycle chain, which would span the distance between these two gears in an adjustable fashion, so that the motor 1 can be fit onto an assortment of different bicycles. Teeth are not shown on these two connected gears, nor on the bicycle chain gear 18, in FIGS. 1 and 2, but should be understood to be present for the engagement of the chain in the usual manner. Also, the driven gear 13 and bicycle chain gear 18 are shown in FIG. 2 as being the same size, but can be adjusted in diameter with respect to each other and with respect to the drive gear 11 as required for appropriate gear ratios.

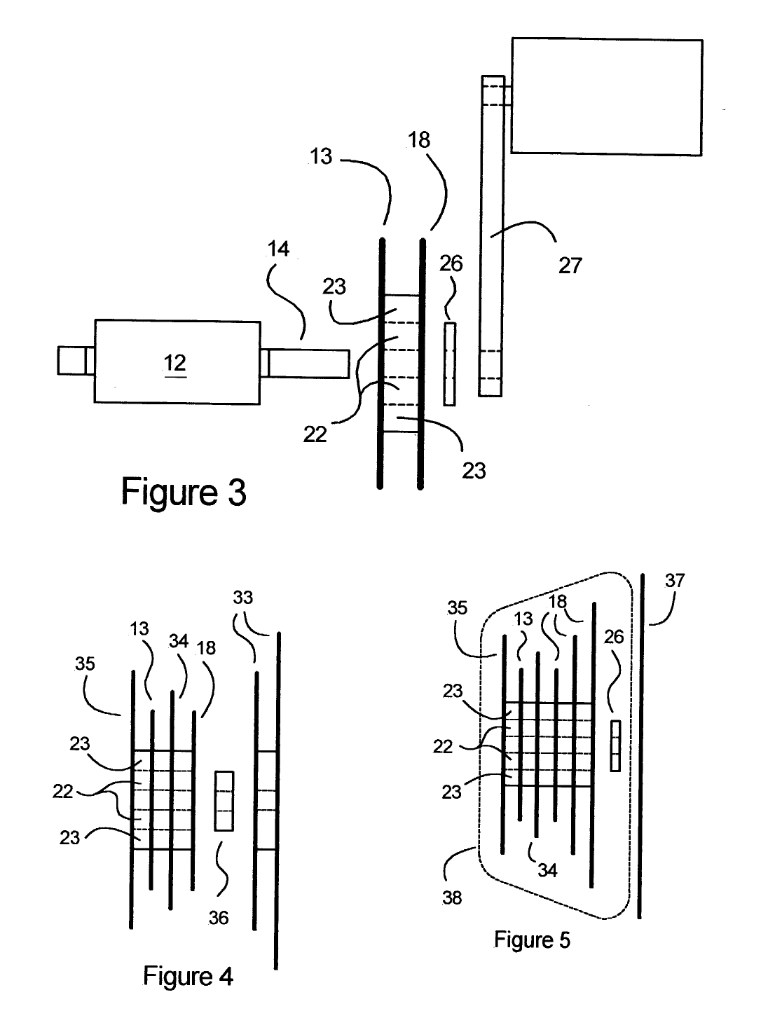

In the configuration shown in FIGS. 2 and 3, there is a replacement of the pedal crank shaft 14 in the bottom bracket 12, which allows for the insertion of the driven gear 13 in addition to the gear or gears 18 for the transmission of the bicycle chain 20 to the rear wheel. The replacement crank shaft 14 is shown in FIG. 2 to be elongated on one side, so that onto this longer side can be fit the driven gear 13 and bicycle chain gear or gears 18 and so on. The bottom bracket 12 is shown in FIG. 2 as a sealed unit, which would contain the bearings that allow the crank shaft 14 to be supported and still to turn freely. This sealed bottom bracket 12 could be replaced as a unit that would be screwed into the frame of the bicycle by means of the threads 21 that are provided on its outer surface, in the same manner as was the original. Alternatively, and in bicycles wherein the bottom bracket is not made as a sealed unit but rather as a loose collection of parts, all the same parts could be used except the pedal crank shaft, which would be replaced.

One or more of the bicycle chain gears 18 are rigidly fixed to the driven gear 13, and therefore can also be powered by the motor 1. Between the driven gear 13 and powered bicycle chain gear or gears 18 and the pedal crank shaft 14 is a one way clutch 22, which is oriented so that the motor 1 can turn and transmit its torque through the driven gear 13 and powered gears 18 and bicycle chain 20 to the rear wheel while the pedals are at rest. Conversely, if the pedals and pedal crank shaft 14 are turned with respect to the powered gears 18, in the usual manner that is used to drive a bicycle, then this clutch 22 can be engaged and power can be transmitted from the pedals to the powered gears 18. Clutches of this kind have been used in the rear sprocket arrangement of bicycles for the past hundred years and more, and there is an entire subclass of the US patent classification system that is essentially devoted to these devices. Those interested in more detailed design possibilities are referred to the US Patent Classification Class 192 Subclass 64. The driven gear 13 and powered bicycle chain gear 18 that are shown in FIG. 2 are separated by a spacer 23 and then fixed to each other and to the one way clutch 22 by means of bolts 24 that can be screwed into an extended portion 25 of the clutch unit 22. After being fit over the pedal crank shaft 14, this set of gears is shown as being held in place by another spacer 26, that keeps them apart from the pedal crank arm 27 which is fixed onto the pedal crank shaft 14 with another bolt 28 in the usual fashion. Alternatively, in the extended portion 25 of the clutch unit 22, large portions 29 of what is shown in FIG. 2 to be a disc could be cut away, as indicated by the dashed lines, leaving only the parts that are needed for the attachment of the bolts 24. Similarly, portions 30 of the driven gear 13 and spacer 23 and powered gear 18 could be cut away, again as indicated by the dashed lines, in order to reduce the weight of these pieces. This is a common practice in the manufacture of bicycles, as is the utilization of cog like protrusions like those 31 shown here for the engagement of matching indentations 32 in the driven gear 13 and powered bicycle chain gear 18.

In the case of a bicycle with a single bicycle chain gear in the bottom bracket area, the single gear would be replaced with two gears that are fixed relative to each other. One of these gears 13 would be dedicated to receive the motorized chain 19 from the motor, and the other 18 would carry the bicycle chain 20 that connects to the rear hub and wheel. These have been referred to as the driven gear 13 and the powered gear 18, respectively, and are shown again in FIG. 3. When the motor is intended to be started, and in the case of a gasoline powered engine, the pedals can be used to drive the powered gear 18 and driven gear 13 through the one way clutch 22, and then to drive the motorized chain 19 and the motor 1 through the second clutch 10. In the case of an electrical motor, the motor can be started at any time through a simple switch. In either case, once the motor is started, it can be used as the sole means of propulsion for the bicycle, while the pedals remain at rest because of the disengagement of the one way clutch, or else as a second drive for the bicycle, with an added effort from the rider. In addition, the second clutch 10 can allow the engine to continue to run when the bicycle is brought to a stop, and then the power from the motor can be smoothly increased in bringing the bicycle back into motion.

In the case of a bicycle with multiple bicycle chain gears in the bottom bracket area, at least one of the bicycle chain gears 18 in the replacement would be fixed in relation to the driven gear 13. The others 33 would be fixed in relation to the pedal crank arm 27, as are the usual bicycle chain gears, and in order to make use of the motor 1 and powered gears 18, it would be necessary to shift the bicycle chain 20 onto these powered gears 18 through the usual means. It would also be necessary, in the case of a gasoline powered engine 1, to shift the bicycle chain 20 onto the powered gears 18 before attempting to use the pedals to drive the motor 1 and start the engine 1. It is this arrangement that is illustrated in FIG. 4. Also shown in FIG. 4 is a plate 34 that would serve to isolate the driven gear 13 from the powered gear 18, so that the bicycle chain 20 cannot be shifted accidentally onto the driven gear 13. Another plate 35 would serve to isolate the driven gear 13 and motorized chain 19 from pant legs and fingers and so on. Both plates are round when viewed from the side, as is the spacer 36 that serves a similar purpose to the spacer 26 that was described in connection with FIGS. 2 and 3.

Operation of the system can be somewhat simplified if all of the bicycle chain gears 18 are fixed as a unit to the driven gear 13, in which case the motor 1 can be started and used in the manner already described, without the need to shift the bicycle chain 20 onto a particular gear or gears. It is this arrangement that is illustrated in FIG. 5. In addition, another plate 37 is included that would serve to isolate the set of powered gears from the rider's clothing. Alternatively, a casing 38 around the entire set of gears and extending up to the motor 1 could be used to enclose the parts of the motorization apparatus that are external to the motor 1 itself.

The embodiments of the invention in which an exclusive property or privilege is claimed are defined as follows:

1. A system for the motorization of a common bicycle, which comprises
a motor and a drive gear which is the output mechanism from the motor,
a driven gear which is coaxial with the bicycle chain gear or gears in the bottom bracket area, and which is connected with the drive gear and at least one of these bicycle chain gears,
a one way clutch between the powered bicycle chain gear or gears and the pedal crank shaft, which is oriented so that these powered gears can be turned while the pedals are at rest, but that can also be engaged and used to drive the bicycle chain gear or gears if the rider pedals in the usual fashion, and
a clutch for the motor, which is capable of a graduated engagement, and which can be controlled in the degree of its engagement by the operator of the bicycle.

2. The system described in claim 1, wherein straps are attached to the motor, which straps are then wrapped around the tubular elements of the frame of the bicycle and used to attach the motor to the bicycle.

3. The system described in claim 2, wherein the motor occupies the space between the seat tube, top tube, head tube and angled down tube.

4. The system described in claim 3, and wherein the drive gear and driven gear are connected by means of a chain that is similar to the usual bicycle chain.

5. The system described in claim 1, wherein the clutch for the motor is located within the motor unit itself, and can be used to control the degree of engagement between the motor and its drive gear.

6. The system described in claim 1, wherein the clutch for the motor is located between the driven gear and the one way clutch that is provided for the pedals.

7. The system described in claim 5, and wherein the degree of engagement of the clutch for the motor is under direct control through manual controls that are available to the operator of the bicycle.

8. The system described in claim 7, and wherein the manual control for the clutch for the motor is in the form of a lever which is identical with one of the levers used to control the brakes.

9. The system described in claim 5, and wherein the degree of engagement of the clutch for the motor is under indirect control through control of the RPM of the motor.

10. The system described in claim 6, and wherein the degree of engagement of the clutch for the motor is under indirect control through control of the RPM of the motor.

11. The system described in claim 1, and wherein the driven gear is rigidly fixed to the powered bicycle chain gear or gears and to the one way clutch that is located between these gears and the pedal crank shaft.

12. The system described in claim 11, wherein the connection of the driven gear and bicycle chain gear or gears and one way clutch is made by means of bolts that pass through portions of each.

13. The system described in claim 12, and which, in addition to the bolts for the connection of the various pieces, also makes use of protrusions from the surface of the one way clutch device and matching indentations in the driven gear and bicycle chain gear or gears for the same purpose.

14. The system described in claim 11, and wherein the pedal crank shaft in the original configuration of the bicycle is replaced with a crank shaft that is elongated on one side, onto which side is then fit the one way clutch device.

15. The system described in claim 1, and in which also meets the requirements of claims 4 and 5 and 11.
